(19) United States
(12) Patent Application Publication
(10) Pub. No.: US 2010/0101966 A1
(43) Pub. Date: Apr. 29, 2010

(54) EXTRACTION BAG AND PACKING MATERIAL

(75) Inventor: Tsunehiro Shimizu, Makinohara-shi (JP)

Correspondence Address: OLIFF & BERRIDGE, PLC, P.O. BOX 320850, ALEXANDRIA, VA, 22320-4850, US

(73) Assignees: OGURINOUEN CO., LTD., MAKINOHARA-SHI (JP); FUSO INDUSTRY CO., LTD., KIKUGAWA-SHI (JP)

(21) Appl. No.: 12/449,605

(22) PCT Filed: Feb. 14, 2008
(86) PCT No.: PCT/JP2008/052402

§ 371 Date: Aug. 17, 2009

(30) Foreign Application Priority Data
Mar. 12, 2007 (JP) 2007-061773

(51) Int. Cl. B65D 85/812; B32B 3/10

(52) U.S. Cl. 206/5; 428/78

(57) ABSTRACT

A basal portion for locking and fixing of hanging yarn (7) to bag main body (3) is determined in accordance with the amount of extraction subject mass (T) placed in the bag main body so that within the plane of top face triangle (12) as a constituent of the bag main body (3) of inverted triangular pyramid form with its vertex downward, the vertex comes on a line connecting the basal portion and gravity center (d) or in the vicinity thereof when the bag main body (3) is hung. When the bag main body (3) is pulled up by pinching tag (5), the hot water as extractant within the bag main body (3) rapidly falls by virtue of the weights of the extraction subject mass (T) and hot water therearound to thereby attain complete pouring within a relatively short period of time.

### FIELD OF THE INVENTION

The present invention relates to an extraction bag provided with a hanging thread, and a packing material used to manufacture the extraction bag.

### BACKGROUND OF THE INVENTION

Conventionally, as an extraction bag with tea leaf or the like packed and sealed therein, an extraction bag to which a hanging thread is attached so that the extraction bag can be easily pulled up after use is commercially available.

In extraction of tea leaf, particularly, it is known that the flavor is remarkably intensified by pouring up to the last drop, and this last drop is called “golden drop” in the case of red tea.

Therefore, it is strongly desired to fall the last drop into a cup for enjoying the flavor also in the case of using the extraction bag.

Patent Literature 1: Japanese Patent Application Laid-Open No. 2002-211641

### DISCLOSURE OF THE INVENTION

### Problem to be Solved by the Invention

Although a flat bag-shaped bag main body is predominantly employed in the conventional extraction bags, an extraction bag provided with a triangular pyramid-shaped bag main body as shown in Patent Literature 1 is also increasingly commercially available in recent years. According to such a bag main body formed in a triangular pyramid shape, the volume within the bag main body is increased, when expanded, to facilitate flowing of the tea leaf packed therein, whereby the extraction efficiency is enhanced.

However, both the flat bag-shaped bag main body and the triangular pyramid-shaped bag main body are difficult to reach the last drop since a small quantity of hot water stays within the bag main body when pulled up from a cup filled with hot water. On the other hand, when the bag is forcedly shaken to hasten the extraction, even astringent component is extracted.

Additionally, a hanging thread extremely short in length tends to fall into the cup during extraction within the cup, and unsanitary falling of a tag into the cup follows such falling of the hanging thread.

Considering economics, furthermore, it is desirable to use a conventional tea bag manufacturing device in the market as it is.

In order to solve the above-mentioned problems, the present invention provides an extraction bag, capable of attaining complete pouring within a relatively short period of time, compared with conventional products.

The present invention further provides an extraction bag, capable of attaining a hanging thread having a length equal to or, in some cases, more than a conventional one.

Moreover, the present invention provides a packing material for manufacturing an extraction bag, which allows use of a conventional manufacturing device in the market as it is.

### Means to Solve the Problems

As a result of the earnest studies to solve the above-mentioned problems, the present inventors found that the above-mentioned problems can be simultaneously solved by setting the fixing position of a base portion of a hanging thread to a bag main body based on a predetermined principle, and consequently accomplished the present invention.

In a first aspect of the present invention, an extraction bag includes a bag main body with an extraction subject mass packed therein and a hanging thread having a base portion fixed to the bag main body, in which the bag main body has an inverted triangular pyramid shape with its vertex downward, and the base portion to be fixed of the hanging thread is set, within the plane of a top face triangle as a constituent of the bag main body of the inverted triangular pyramid shape with its vertex downward, to a position where the vertex comes on a line connecting the base portion to be fixed of the hanging thread to the center of gravity or in the vicinity thereof when the bag main body is hung.

In a second aspect of the present invention, it is included in the first aspect of the invention that the fixing position of the hanging thread is provided, within the plane of a sectional triangle having the height line of the top face triangle as a horizontal upper side and lines connecting both ends of the height line to the vertex as lateral sides, at the foot of a perpendicular drawn from a position of the center of gravity which is appropriately predicted according to the quantity of the extraction subject mass packed in the bag main body on a centroidal line dividing the upper side along the vertex in 1:2 to the upper side or in the vicinity thereof.

In a third aspect of the present invention, it is included in the first or second aspect of the invention that the bag main body is formed in a triangular pyramid shape by mutually fitting and vertically sealing vertical edge portions of a continuous lengthy packing material sheet to form a cylindrical body, and performing horizontal sealing to the cylindrical body at two appropriately-spaced upper and lower parts thereof in mutually orthogonal directions, and the fixing position of the hanging thread is provided on the vertical seal part within the plane of the top face triangle or in the vicinity thereof.

In a fourth aspect of the present invention, it is included in the third aspect of the invention that the vertical seal part extends in parallel to the height line of the top face triangle with a slight space therefrom, and the fixing position of the hanging thread is provided on the height line of the top face triangle.

In a fifth aspect of the present invention, a packing material for manufacturing the extraction bag according to the third or fourth aspect of the invention comprises a continuous lengthy sheet for constituting a bag main body; a plurality of tags engagingly fixed to one width directional end side of the sheet; and a plurality of hanging threads extending across the width direction of the sheet, with a free end thereof being fixed to the tag on one-to-one basis and a base portion thereof being fixed to the other width directional end side of the sheet, wherein the plurality of tags is engagingly fixed at equal intervals in the longitudinal direction of the sheet, and the fixing position of the base portion of each hanging thread is set to a position higher or lower in level than the engagingly fixing position of the corresponding tag relative to the longitudinal direction by the same extent, the positions of the hanging threads adjacent to each other in the longitudinal direction being alternately high and low in level.

In a sixth aspect of the invention, it is included in the fifth aspect of the invention that the hanging thread is slack between the base portion fixed to the bag main body and the free end fixed to the tag.

### EFFECT OF THE INVENTION

According to the extraction bag of the present invention, complete pouring can be rapidly attained.

The length of the hanging thread can be easily increased according to the purpose of the extraction bag. According to the packing material of the invention, a conventional manufacturing device in the market can be used as it is.

### BRIEF DESCRIPTION OF THE DRAWINGS

FIG. 1 is an illustrative view of a usage state of an extraction bag according to a first embodiment of the present invention;

FIG. 2 is a plan view of the tag attachment side of a packing material for the extraction bag shown in FIG. 1;

FIG. 3 is an illustrative view of a sealing procedure for forming a triangular pyramid-shaped bag main body from the packing material shown in FIG. 2;

FIG. 4 are views for illustrating a simple calculation method for the fixing position of a hanging thread to a sheet in the extraction bag shown in FIG. 1;

FIG. 5 is a view for illustrating the simple calculation method for the fixing position of the hanging thread to the sheet in the extraction bag shown in FIG. 1;

FIG. 6 is a view for illustrating the fixing position of the hanging thread to the sheet in use of a packaging material of a certain dimension;

FIG. 7 is a plan view of the tag mounting side of a packing material according to a second embodiment of the invention;

FIG. 8 is a plan view of the tag mounting side of a packing material according to a third embodiment of the invention;

FIG. 9 is a plan view of the tag mounting side of a packing material according to a fourth embodiment of the invention;

FIG. 10 is a plan view of the tag mounting side of a packing material according to a fifth embodiment of the invention; and

FIG. 11 is a perspective view of a bag main body formed from the packing material according to the fifth embodiment of the invention.

### DESCRIPTION OF REFERENCE NUMBERS

1 . . . Extraction bag, 3 . . . Bag main body, 5 . . . Tag, 7 . . . Hanging thread, 9 . . . . Packing material (First embodiment), 11 . . . Sheet, 12 . . . Top face triangle, 13 . . . Vertical seal part, 14 . . . Sectional triangle, 15, 17 . . . Horizontal seal part, 19 . . . Packing material (Second embodiment), 21 . . . Hanging thread, 23 . . . Packing material (Third embodiment), 25 . . . Hanging thread, 27 . . . Height line, 29 . . . Packing material (Fourth embodiment), 31 . . . Hanging thread, 33 . . . Packing material (Fifth embodiment), T . . . Extraction subject mass (Red tea leaf), a, b . . . Both ends of vertical seal part (=Both end points of upper side), c . . . . Vertex, d . . . . Center of gravity of extraction subject mass, e . . . . Center of gravity of top face triangle, f . . . Foot of perpendicular passing through the center of gravity d, g . . . Foot of perpendicular passing through the vertex c; h . . . Center point, i . . . Fixing position, j1, j2 . . . Height position

### BEST MODE FOR CARRYING OUT THE INVENTION

An extraction bag 1 according to a first embodiment of the present invention will be described in reference to the drawings.

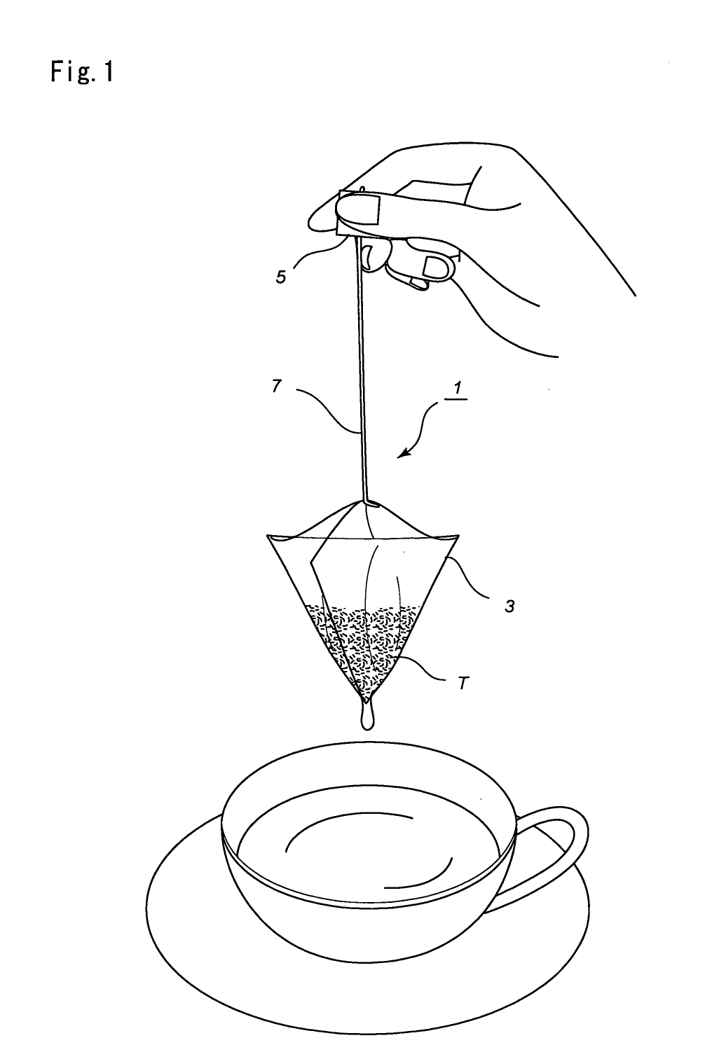

FIG. 1 is a perspective view of a usage state of the extraction bag 1 as a tea bag, in which a last drop is just falling from the extraction bag.

A bag main body 3 of the extraction bag 1 has an inverted triangular pyramid shape in an expanded state, with each plane thereof being composed of an isosceles triangle.

Denoted at 5 is a tag, and a free end of a hanging thread 7 is fixed to the tag 5 by ultrasonic welding method, while a base portion of the hanging thread 7 is fixed to the bag main body 3 in the same manner.

The hanging thread 7 is fixed at a specific position within the plane of a top face triangle 12 constituting the upper surface of the inverted triangular pyramid-shaped bag main body 3. The fixed portion is the base portion of the hanging thread 7.

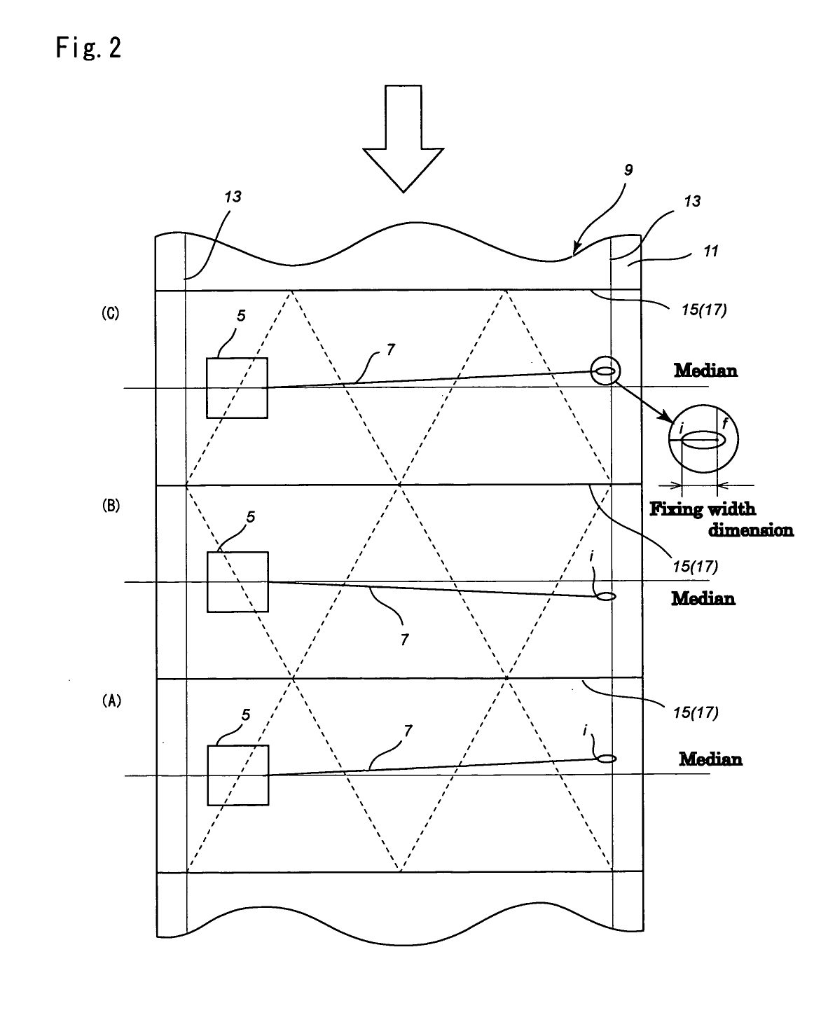

When an actual tea bag manufacturing device in the market is used for manufacturing the extraction bag 1, a sheet 11 of a continuous lengthy packing material 9 as shown in FIG. 2 is fed in an arrowed direction, subjected to vertical sealing and cutting in a wound state, and thereby formed into a cylindrical body bonded at a vertical seal part 13.

Horizontal sealing and cutting are then simultaneously performed, whereby the top of a packing material A is dosed on the downstream side across a resulting horizontal seal part 15, and the bottom of a packing material B is dosed on the upstream side.

The horizontal sealing and cutting are further simultaneously performed after feeding the resulting sheet to the front of a horizontal sealing machine with a predetermined pitch distance, whereby the top of the packing material B is closed on the downstream side across a resulting horizontal seal part 17, and the bottom of a packing material C is closed on the upstream side. Input (packing) of an extraction subject mass (red tea leaf) T is performed before closing the top of the packing material after dosing the bottom of the packing material.

The top and bottom of the bag main body 3 are horizontally sealed in vertically orthogonal directions to each other so that the bag main body 3 has a triangular pyramid shape when expanded. The dotted line in the drawings shows a part constituting each side of the triangular pyramid shape when the bag main body is expanded in the triangular pyramid shape, and the position of the dotted line is determined depending on the folding positions of the cylindrical body in the horizontal sealing operations. In the case of FIG. 2, the dotted line is drawn in a shown position since one folding position is on the vertical seal part 13.

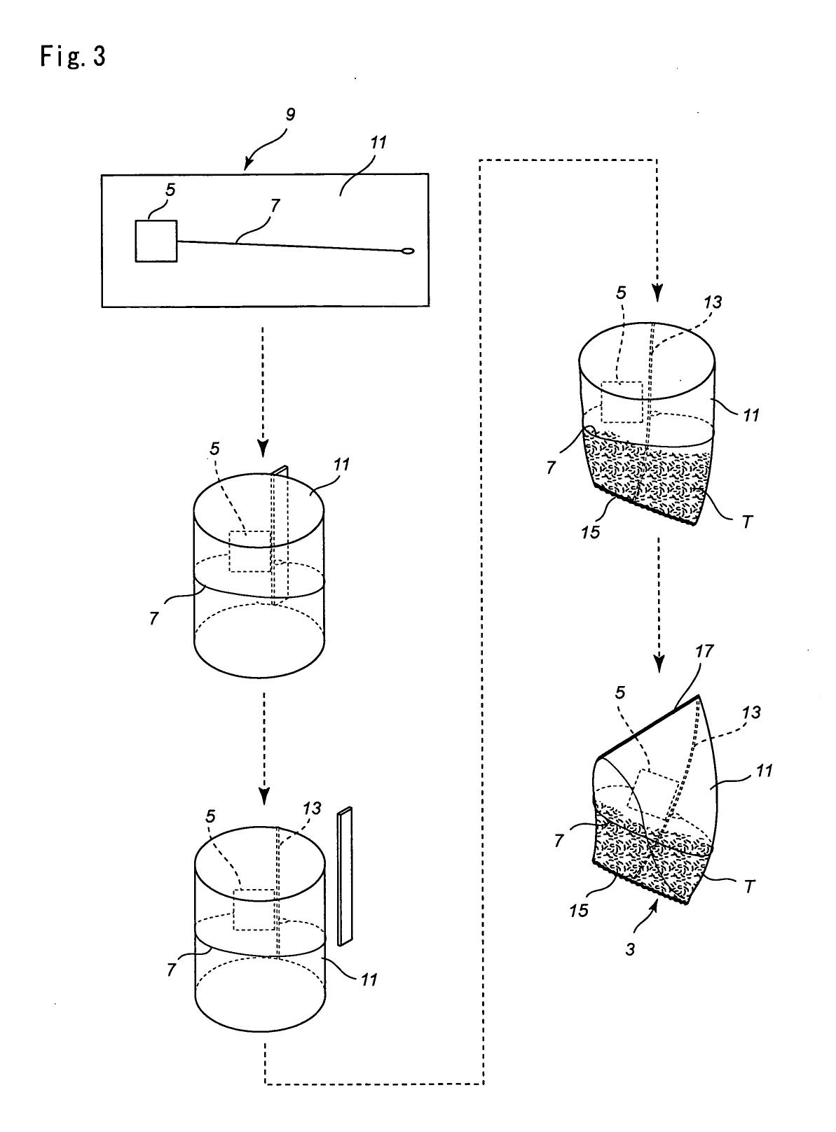

FIG. 3 illustrates the sealing procedure, focusing on one extraction bag 1 formed by the packing material B.

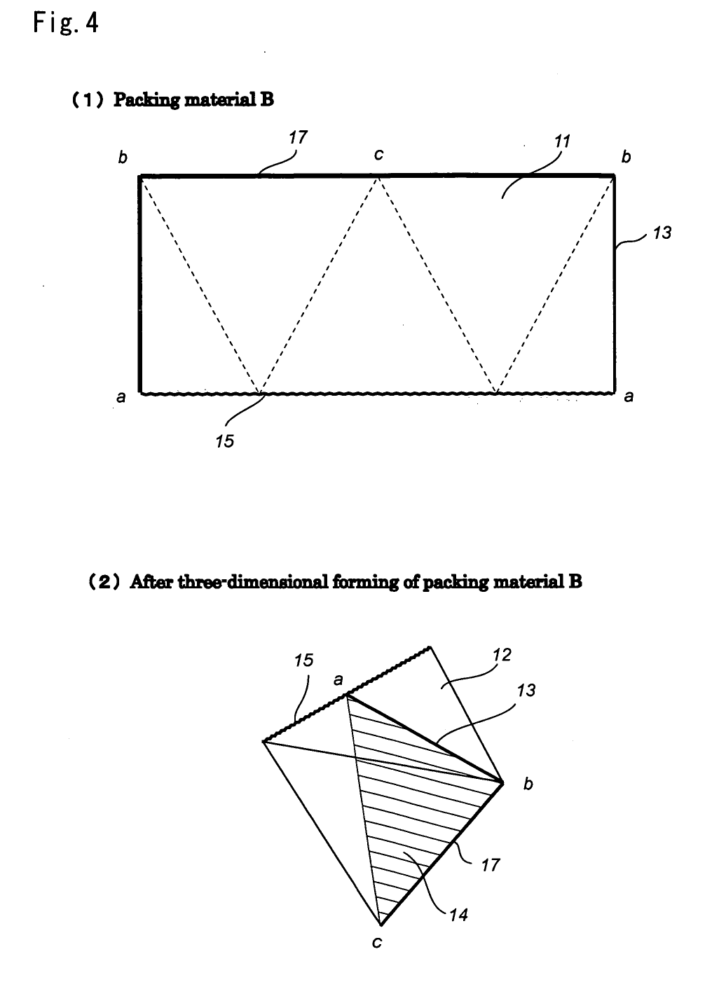

FIG. 4(1) shows the packing material B serving as one bag main body 3 formed by sealing and cutting, and FIG. 4(2) is a perspective view of an inverted triangular pyramid holding the shape in an ideal state, which is formed by sealing the packing material B and bending the sheet 11 along the dotted line while smoothing the flexure of the sheet 11, and each triangle is drawn in a planar ideal state in the drawing.

Each of triangles constituting the triangle pyramid shown in FIG. 4(2) has an isosceles triangular shape or an equilateral triangular shape in a special case.

The dimensional relation of the triangular pyramid is determined depending on the width and pitch of the sheet 11.

Standardized dimensions are generally designated to the tea bag manufacturing devices in the market and, for example, four standardized dimensions of width of sheet 11: 140 mm (+2.0 to −0.5) and pitch: 58 mm (±1.5); width of sheet 11: 160 mm (+2.0 to −0.5) and pitch: 65 mm (±1.5); width of sheet 11: 140 mm (+2.0 to −0.5) and pitch: 52 mm (±1.5); and width of sheet 11: 160 mm (+2.0 to −0.5) and pitch: 60.6 mm (−1.5) are set thereto.

Each of the above-mentioned four standardized dimensions is used for a triangular pyramid-shaped bag, and a triangular pyramid shape composed of equilateral triangles is obtained when the latter two standardized dimensions are adapted.

A simple calculation method for the fixing position of the base portion of the hanging thread 7 will be described using FIG. 4.

As shown in the development view of FIG. 4(1), when the horizontal seal part 15 is adjusted so that the vertical seal part 13 (the line connecting both ends “a” and “b”) corresponds to the height line of a top face triangle 12, a sectional triangle 14 (a part shown with diagonal lines) having the line connecting both the ends “a” and “b2 of the vertical seal part 13 as a horizontal upper side and a vertex “c” as a bottom end is defined as shown in the three-dimensional view of FIG. 4(2). The center of gravity d of the extraction subject mass T is regularly located within the plane of the above-mentioned sectional triangle 14 regardless of its packing quantity.

The center of gravity “d” of the extraction subject mass T corresponds to a point which internally divides a segment line “ce” connecting the vertex “c” to the center of gravity “e” of the top face triangle 12 (=on a center of gravity line) in a ratio of 3:5, and the center of gravity “e” of the top face triangle 12 corresponds to a point which internally divides the upper side “ab” in a ratio of 1:2.

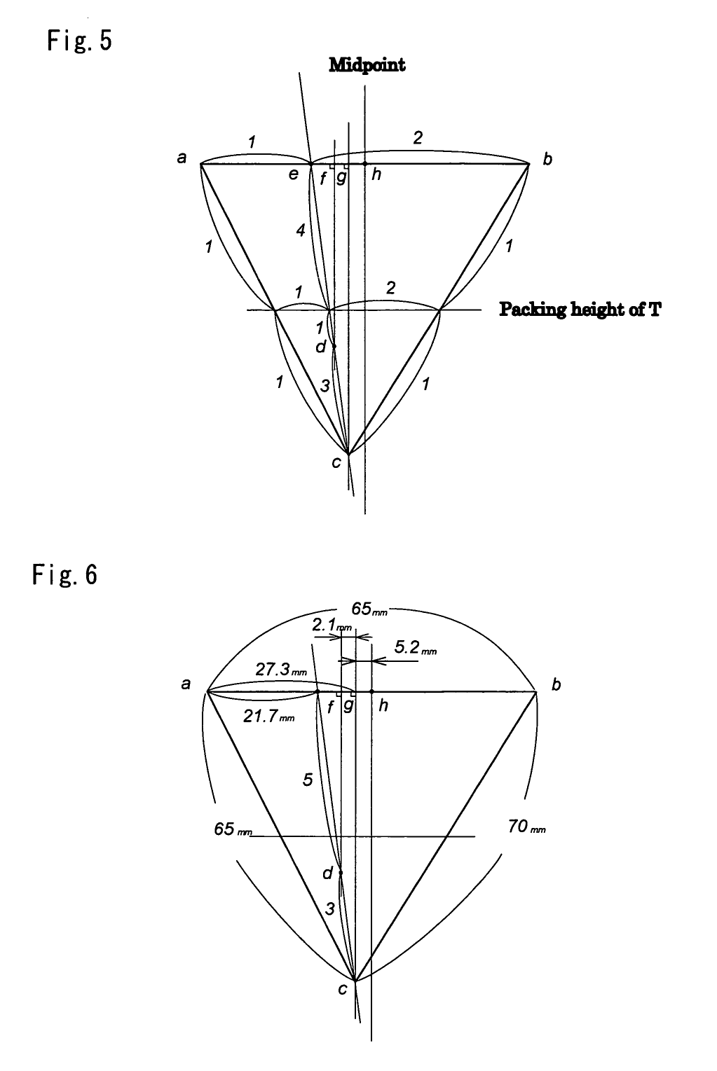

When the extraction subject mass T is packed up to the level of half the height so that the packed shape is substantially similar to the inverted triangle pyramid of the bag main body 3, a dimensional relation as shown in FIG. 5 is obtained.

When the hanging thread 7 is fixed with the foot “f” of a perpendicular drawn from the center of gravity “d” to the upper side “ab” as a fixing position, the line of action and the line of support of the gravity are aligned. Accordingly, a good balance of power can be ensured, and the upper side “ab” is horizontally held in an ideal relation with the vertex “c” being just below the center of gravity “d”. By setting this state, the weight of the extraction subject mass T and hot water around it can be most efficiently used to completely pour the extraction liquid.

When the isosceles triangles constituting the bag main body 3 are not equilateral triangles, the foot “f” of the perpendicular passing through the center of gravity “d” and the foot “g” of a perpendicular passing through the vertex “c” are horizontally shifted. Therefore, in a strict sense, the vertex “c” comes to a position shifted from just below the center of gravity “d” in the above-mentioned horizontal state when the bag main body 3 is pulled up by pinching the tag 5 through the hanging thread 7.

However, if the foot “f” of the perpendicular passing through the center of gravity “d” and the foot “g” of the perpendicular passing through the vertex “c” are positioned close to each other within 5 mm of distance “fg” between both the foots “f” and “g”, the vertex “c” comes substantially just below the center of gravity “d”, and the extraction liquid can be therefore completely poured with sufficiently high efficiency.

When the vertical seal part 13 is taken as the upper side, as shown in FIG. 4(2), a fixing position “i” retreating inwardly over the vertical seal part 13 is an actual fixing position for stably fixing the hanging thread 7 to the bag main body 3 with a certain fixing width dimension.

Although the weight can be most efficiently used to perform complete pouring of the extraction liquid as described above when the fixing position “i” is matched to the foot “f” of the perpendicular, the complete pouring can be performed with sufficient efficiency if the both are close to each other within 8 mm, preferably, within 5 mm of inwardly retreating distance from the vertical seal part 13.

When the vertex “c” is substantially just below the center of gravity “d” as in this embodiment, the hot water as the extraction liquid within the bag main body 3 rapidly falls by virtue of the weight of the extraction subject mass T and hot water around it when the bag main body 3 is pulled up by pinching the tag 5, and the complete pouring can be thus attained within a relatively short period of time

Further, the hanging thread 7 is obliquely extended to the vicinity of the vertical edge of the packing material 9 substantially across the width direction thereof, and thus increased in length, compared with the case in which it is horizontally extended across the width direction.

When the packing material shown in FIG. 4(1) has, for example, a dimension of sheet width: 160 mm and pitch: 65 mm, and this packing material is cut 10 mm each from both end sides by vertical sealing and cutting, a sectional triangle 14 shown in FIG. 6 is obtained.

In this case, as shown in FIG. 6, the distance “fg” between the foot “f” of the perpendicular that is an ideal fixing position of the hanging thread 7 and the foot “g” of the perpendicular passing through the vertex “c” is 2.1 mm, based on the above-mentioned simple calculation method, and the foot “f” of the perpendicular is shifted 7.3 mm to the left from the midpoint “h” of the upper side “ab”.

Since the upper side “ab” corresponds to the vertical seal part 13 having one-pitch length, the fixing position i of the hanging thread 7 is lower in level by 7.3 mm than the median line in the longitudinal direction of the sheet 11.

The fixing position “i” is retreated inwardly within 8 mm.

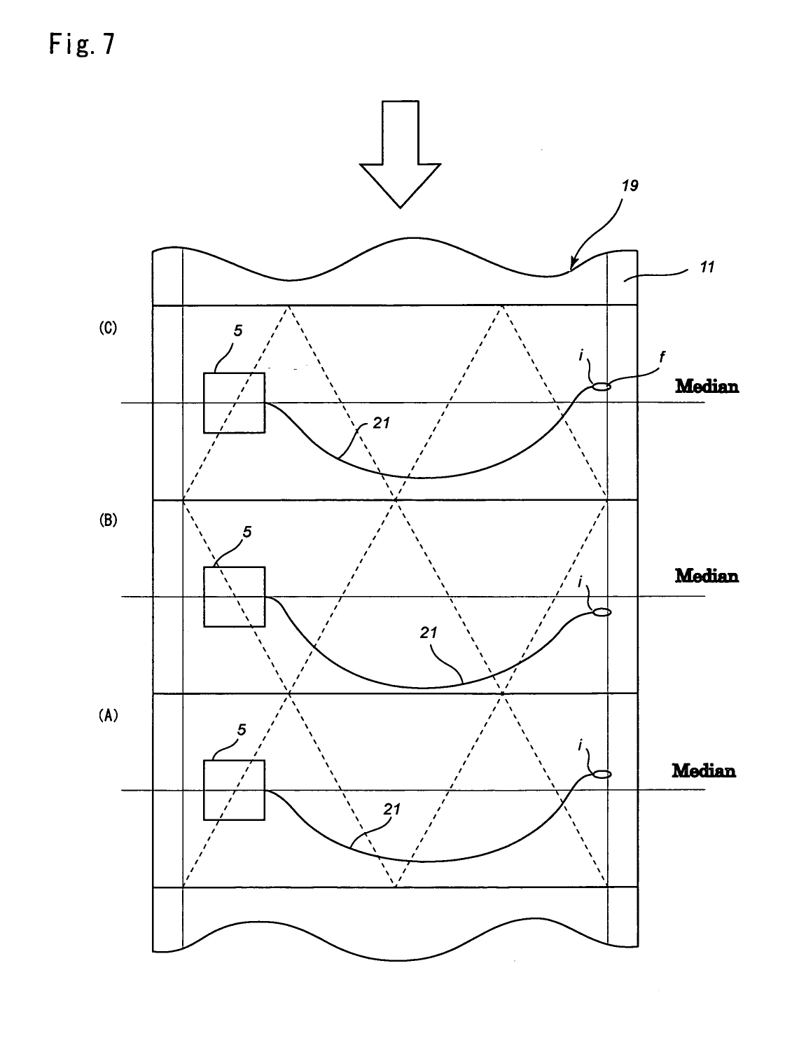

FIG. 7 shows another packing material 19 according to a second embodiment, and the packing material 19 includes a slack hanging thread 21. The length of the hanging thread 21 can be further increased by making the hanging thread 21 slack in such a manner.

Description for parts used in common with the first embodiment is omitted by assigning the same reference numbers thereto. The same goes for the following embodiments.

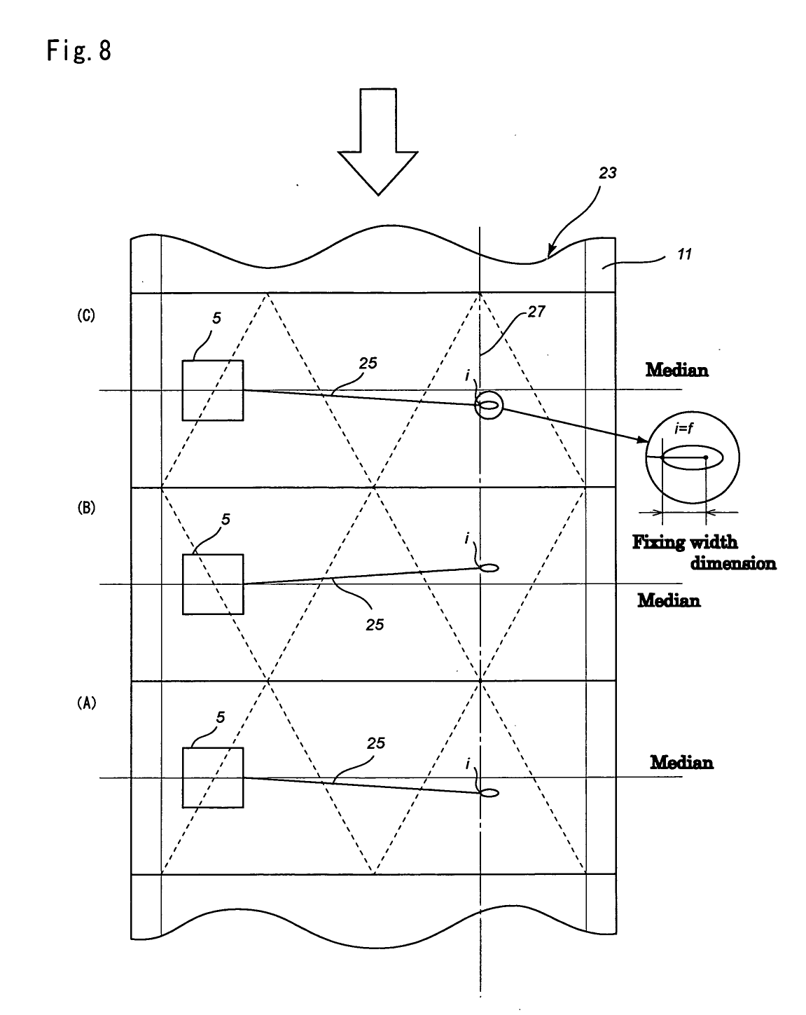

FIG. 8 shows another packing material 23 according to a third embodiment of the invention. In the packing material 23, a hanging thread 25 is fixed not to the vicinity of the vertical seal part 13, but onto a height line 27 of a triangle adjacent to a triangle containing the vertical seal part 13 within its plane.

Such structure can be adapted if it is acceptable that the hanging thread 25 is short. According to this structure, just the position of the foot “f” of the perpendicular can be set as the fixing position “i”.

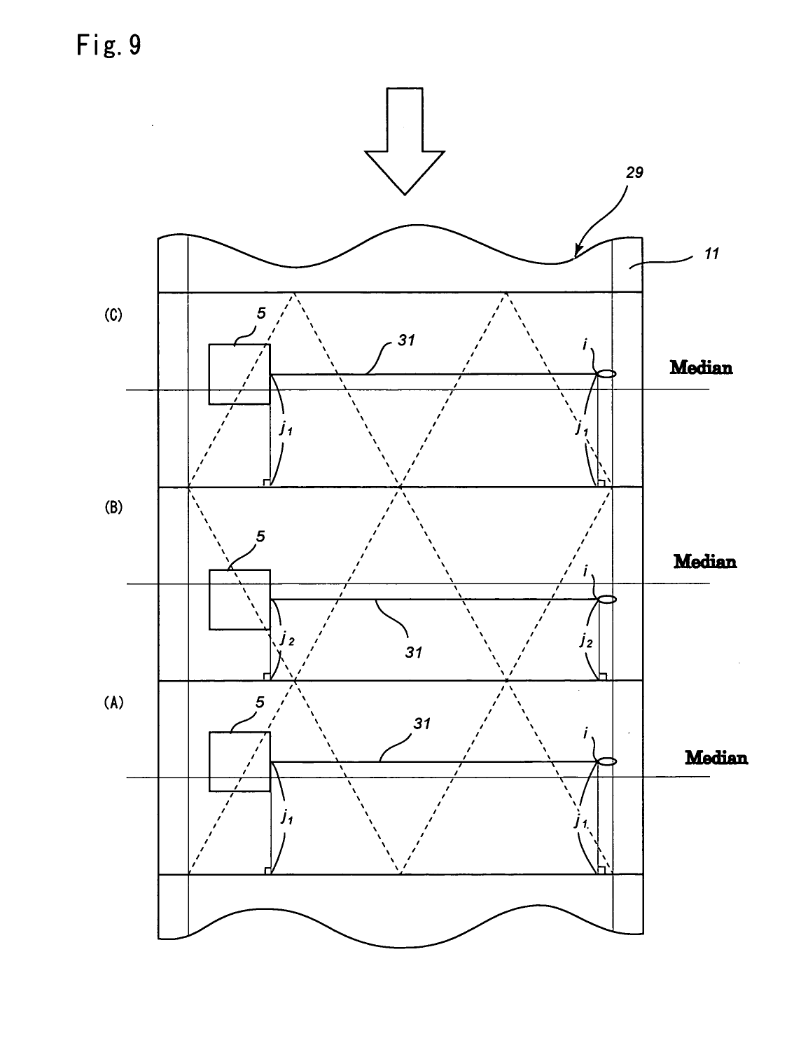

FIG. 9 shows another packing material 29 according to a fourth embodiment of the invention. In this packing material 29, the engaging fixing interval of the tag 5 is not constant.

Although an equal pitch distance is set as the engaging fixing interval of tag in a conventional tag attaching machine, the engaging fixing position of the tag 5 and the fixing position of a hanging thread 31 to the sheet 11 can be set to the same height positions (j1 and j2) by changing the engaging fixing position of the tag 5 by sensor control or the like as in this packing material 29.

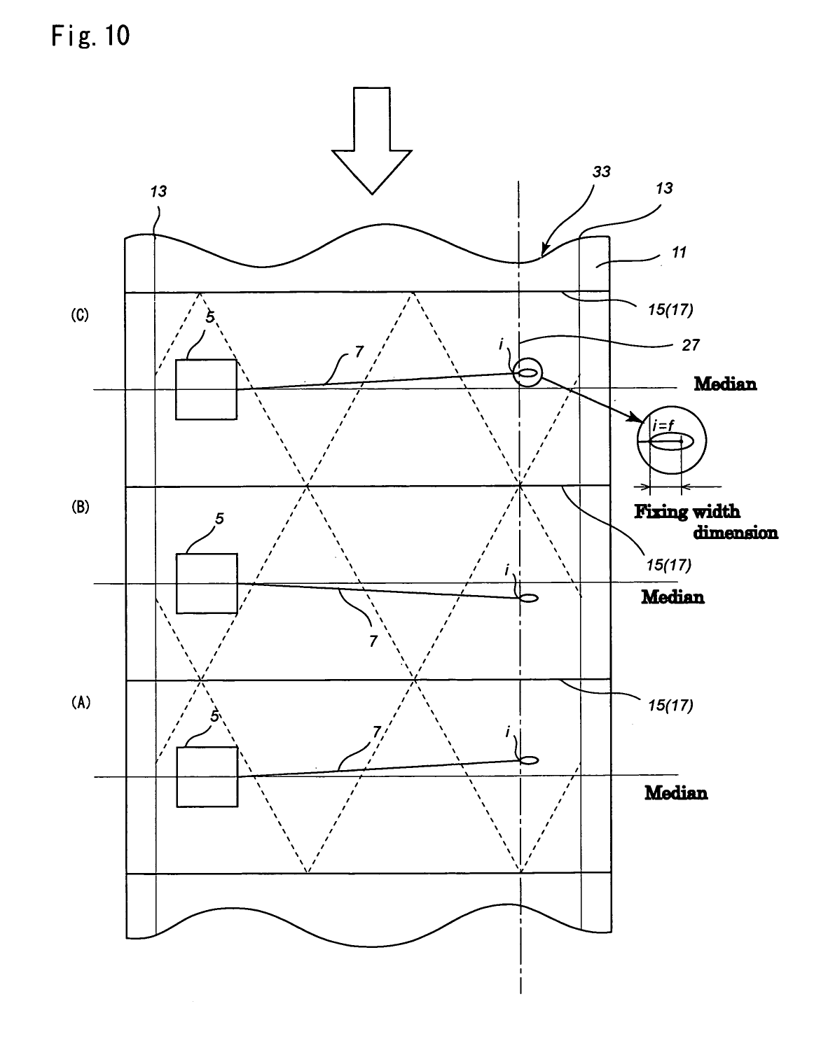

FIG. 10 shows another packing material 33 according to a fifth embodiment of the invention. In this packing material 33, the fixing position “i” of the hanging thread 7 is set to the same height position as the fixing position “i” of the base portion of the hanging thread 7 of the packing material 9 according to the first embodiment, but the former is retreated inwardly more than the latter with respect to the horizontal position.

In the processing of the packing material 9 as described in the first embodiment, highly accurate cutting of both the ends which is simultaneously performed with vertical sealing is required when bag making is carried out while packing the extraction subject mass such as tea leaf through an extraction bag manufacturing device. If the cutting position is inwardly retreated even a little, the resulting fixing width dimension becomes smaller than the original fixing width dimension of the hanging thread 7 or the dimension (i-f) in the first embodiment. Therefore, the fixing strength is reduced, and the hanging thread 7 becomes increasingly likely to fall without standing the weight of hot water when the hanging thread 7 is pulled up.

In contrast, very high cutting accuracy is not required in this packing material 33 since a height line forming the upper side of the sectional triangle 14 (shown with the dashed line) does not overlap with the vertical seal part 13.

Further, just the position of the foot “f” of the perpendicular passing through the center of gravity “d” can be taken as the fixing position.

Although the height line is drawn rather inward for convenience of understanding in FIG. 10, it goes without saying that it is only necessary to set the height line in a position capable of ensuring the original fixing width dimension, even allowing for the cutting accuracy.

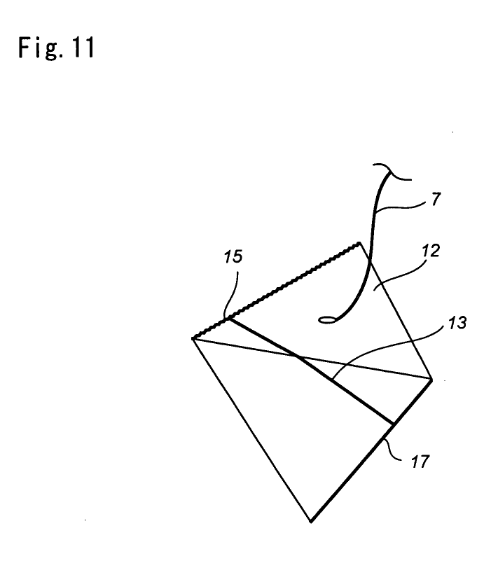

In this case, although the vertical seal part 13 passes through the planes of two triangles, as shown in FIG. 11, the triangular pyramid shape is never particularly easily collapsed during extraction even if that is the case, since the vertical seal part 13 has an extremely small width dimension with almost the same rigidity as that of the circumferential part.

As the material of the sheet 11, for example, plastic nonwoven fabric and mesh such as polyethylene fiber nonwoven fabric and mesh, polypropylene fiber nonwoven fabric and mesh, nylon nonwoven fabric and mesh and the like can be applied.

As the extraction subject mass, general tea leaf including, in addition to red tea, green tea, coffee or the like can be packed.

Having described preferred embodiments of the present invention, it is believed that the concrete structure of the present invention is not limited by the above-mentioned embodiments, and various changes and modifications in design without departing from the spirit and scope of the present invention are also included in the present invention.

That is, with respect to the kinds of constituent materials such as the sheet and the like and the manufacturing device, conventionally available ones or those devised in the future can be optionally used.

### INDUSTRIAL USABILITY

Since the extraction bag of the present invention can relatively quickly perform complete pouring, everyone can easily drink tea or the like, including the last drop by use of this extraction bag.

1. An extraction bag including a bag main body with an extraction subject mass packed therein and a hanging thread having a base portion fixed to the bag main body, wherein:
the bag main body has an inverted triangular pyramid shape with its vertex downward; and
the base portion to be fixed of the hanging thread is set, within the plane of a top face triangle as a constituent of the bag main body of the inverted triangular pyramid shape with its vertex downward, to a position where the vertex comes on a line connecting the base portion to be fixed of the hanging thread to the center of gravity or in the vicinity thereof when the bag main body is hung.

2. The extraction bag according to claim 1, wherein the fixing position of the hanging thread is provided, within the plane of a sectional triangle having the height line of the top face triangle as a horizontal upper side and lines connecting both ends of the height line to the vertex as lateral sides, at the foot of a perpendicular drawn from a position of the center of gravity which is appropriately predicted according to the quantity of the extraction subject mass packed in the bag main body on a centroidal line dividing the upper side along the vertex in 1:2 to the upper side or in the vicinity thereof.

3. The extraction bag according to claim 1, wherein:
the bag main body is formed in a triangular pyramid shape by mutually fitting and vertically sealing vertical edge portions of a continuous lengthy packing material sheet to form a cylindrical body, and performing horizontal sealing to the cylindrical body at two appropriately-spaced upper and lower parts thereof in mutually orthogonal directions; and
the fixing position of the hanging thread is provided on the vertical seal part within the plane of the top face triangle or in the vicinity thereof.

4. The extraction bag according to claim 3, wherein:
the vertical seal part extends in parallel to the height line of the top face rectangle with a slight space therefrom; and
the fixing position of the hanging thread is provided on the height line of the top face triangle.

5. A packing material for manufacturing the extraction bag according to claim 3, comprising a continuous lengthy sheet for constituting a bag main body; a plurality of tags engagingly fixed to one width directional end side of the sheet; and a plurality of hanging threads extending across the width direction of the sheet, with a free end thereof being fixed to the tag on one-to-one basis and a base portion thereof being fixed to the other width directional end side of the sheet, wherein:
the plurality of tags is engagingly fixed at equal intervals in the longitudinal direction of the sheet; and
the fixing position of the base portion of each hanging thread is set to a position higher or lower in level than the engagingly fixing position of the corresponding tag relative to the longitudinal direction by the same extent, the positions of the hanging threads adjacent to each other in the longitudinal direction being alternately high and low in level.

6. The packing material according to claim 5, wherein the hanging thread is slack between the base portion fixed to the bag main body and the free end fixed to the tag.

7. The extraction bag according to claim 2, wherein:
the bag main body is formed in a triangular pyramid shape by mutually fitting and vertically sealing vertical edge portions of a continuous lengthy packing material sheet to form a cylindrical body, and performing horizontal sealing to the cylindrical body at two appropriately-spaced upper and lower parts thereof in mutually orthogonal directions; and
the fixing position of the hanging thread is provided on the vertical seal part within the plane of the top face triangle or in the vicinity thereof.

8. A packing material for manufacturing the extraction bag according to claim 4, comprising a continuous lengthy sheet for constituting a bag main body; a plurality of tags engagingly fixed to one width directional end side of the sheet; and a plurality of hanging threads extending across the width direction of the sheet, with a free end thereof being fixed to the tag on one-to-one basis and a base portion thereof being fixed to the other width directional end side of the sheet, wherein:
the plurality of tags is engagingly fixed at equal intervals in the longitudinal direction of the sheet; and
the fixing position of the base portion of each hanging thread is set to a position higher or lower in level than the engagingly fixing position of the corresponding tag relative to the longitudinal direction by the same extent, the positions of the hanging threads adjacent to each other in the longitudinal direction being alternately high and low in level.
